(19) United States
(12) Patent Application Publication
(10) Pub. No.: US 2026/0024110 A1
(43) Pub. Date: Jan. 22, 2026

(54) Culture, Language, and Behavior Cycle Tool for Targeting Multicultural Consumers

(71) Applicant: AAAZA, Inc., Los Angeles, CA (US)

(72) Inventors: Jay Kim, Glendale, CA (US); Ron Xie, Los Angeles, CA (US)

(21) Appl. No.: 19/200,501

(22) Filed: May 6, 2025

Related U.S. Application Data
(60) Provisional application No. 63/643,268, filed on May 6, 2024.

(51) Int. Cl. G06Q 30/0251

(52) U.S. Cl. CPC G06Q 30/0251

(57) ABSTRACT

A method is disclosed for directing targeted advertisements to potential multicultural consumers, who are a subset of members of an ethnic group associated with a homeland country and a native language. Information data associated with the members of the ethnic group is retrieved, which includes an age, a household size, a household income, and a number of visits to the homeland country for each of the members. A culture cycle model for the ethnic group representing a plurality of life stages of the members is generated, and then at least one of the life stages to which the potential consumers belong is identified. Based on that identified life stage, characteristics of the advertisements to be directed to the potential consumers are determined, including a language of the advertisements, and then the advertisements are directed to the potential consumers.

### CROSS-REFERENCE TO RELATED APPLICATIONS

This application claims priority from U.S. Provisional Application No. 63/643,268 filed May 6, 2024 and titled “Culture, Language, and Behavior Cycle Tool for Targeting Multi-Cultural Consumers,” which is herein incorporated by reference.

### FIELD OF THE INVENTION

This invention relates generally to methods and systems for directing targeted advertisements to multicultural consumers by utilizing a culture, language, and behavior tool as well as using consumers' mobile devices and geofencing.

### BACKGROUND OF THE INVENTION

Targeted advertising is a form of advertising that is directed towards an audience with certain characteristics based on the product being offered for sale. These characteristics can include age, gender, level of education, income level, and/or employment. These characteristics can also include consumer values, personality, attitude, opinion, lifestyle, and interests. Further, behavioral variables, such as browser history, purchase history, and other recent online activities, can be taken into account.

Traditional forms of advertising, such as billboards, newspapers, magazines, and radio channels, are gradually being replaced by online advertising. However, targeted advertising typically does not account for a person's ethnicity and/or culture. Also, it does not account for a level of culture within a certain ethnicity. For example, one Asian person may be a first-generation immigrant who fluently speaks their respective native language and/or frequents locations that particularly serve their respective Asian population, while another Asian person may be a second-generation Asian-American who speaks only English and does not frequent Asian locations. However, current targeted advertising may deliver advertising for an Asian product in an Asian native language without accounting for a person's ethnicity and/or culture.

For example, advertising for a Korean product may be delivered in the Korean language to a Korean-American person who speaks only English. Further, it does not consider that a person's level of culture may change over their lifespan.

### BRIEF SUMMARY OF THE INVENTION

To address these problems, one of the objectives of the present invention is to provide a culture cycle modeling tool that targets different ethnic groups and determines the best way to reach consumers who are experiencing both their native culture and American culture at critical stages of life, such as college, marriage, parenting/having children, identity/having grandchildren, and the like. By identifying the life cycle stage of a potential consumer, culturally relevant advertising may be directed to the potential consumer.

In embodiments of the present invention, a method for directing advertisements to potential consumers of a product is disclosed. The consumers are a subset of members of an ethnic group associated with a homeland country and a native language. The method includes the steps of retrieving information data associated with the members of the ethnic group, which includes an age, a household size, a household income, and a number of visits to the homeland country for each of the members; generating a culture cycle model for the ethnic group representing a plurality of life stages of the members based on the information data associated with the members of the ethnic group; and then identifying in the culture cycle model at least one of the life stages to which the potential consumers of the product belong. Based on this identified life stage, characteristics of the advertisements to be directed to the potential consumers of the product are determined, including a language of the advertisements, and then advertisements are directed in the determined language to the potential consumers of the product.

In particular embodiments, the culture cycle model for the ethnic group is generated using formulas

$$α = \sqrt{number of visits to homeland country \times household size} and$$

$$β = \sqrt{household size \times household income} ,$$

wherein α and β define a height and a width of the culture cycle model. Additionally, each of the members of the ethnic group is assigned to one of a plurality of age groups based on the age of the member, and a quantity of the members belonging to each of the age groups defines a thickness of the culture cycle model at each of the plurality of life stages of the members. Further, determining the characteristics of the advertisements can include choosing between English and the native language associated with the ethnic group as the language of the advertisements.

In other embodiments of the present invention, a method for directing advertisements to potential consumers of a product is disclosed, in which the consumers are a subset of members of an ethnic group associated with a homeland country and a native language. The method includes the steps of identifying a plurality of locations visited by the members of the ethnic group, assigning a culture level rating to each of the plurality of locations based on a frequency of visits by the members of the ethnic group, and generating a geofence associated with each of the plurality of locations. For each of the plurality of locations visited by users having mobile devices, each mobile device having a device identifier assigned to the mobile device, the method also includes the steps of, when a mobile device enters the geofence associated with a selected location of the plurality of locations, retrieving the device identifier assigned to the mobile device, storing the retrieved device identifier in a list of device identifiers assigned to mobile devices that have entered the geofence associated with the selected location, cross-checking the retrieved device identifier for generally daily reoccurrence in the stored list of device identifiers assigned to mobile devices that have entered the geofence associated with the selected location, and removing the retrieved device identifier from the stored list of device identifiers. For each device identifier in the stored lists of device identifiers assigned to mobile devices that have entered the geofences associated with the plurality of locations, the method further includes the step of associating a culture level rating of the mobile device with the device identifier, where the culture level rating of the mobile device is based on a number of the plurality of locations visited by the user of the mobile device and the culture level rating assigned to each of the plurality of locations visited by the user. Finally, the method includes the steps of requesting the device identifiers assigned to the mobile devices with culture level ratings meeting a selected threshold, and directing advertisements to the users of the mobile devices with the requested device identifiers with culture level ratings meeting the selected threshold.

In particular embodiments, the selected threshold is determined by performing the steps of generating a culture cycle model for the ethnic group representing a plurality of life stages of the members based on information data associated with the members of the ethnic group including an age, a household size, a household income, and a number of visits to the homeland country for each of the members; and identifying in the culture cycle model at least one of the life stages to which the potential consumers of the product belong, wherein the selected threshold corresponds to the identified at least one of the life stages of the culture cycle model to which the potential consumers of the product belong. Additionally, the plurality of life stages represented in the culture cycle model include at least college, marriage, parenting, and identity. Further, the culture cycle model for the ethnic group is generated using formulas

$$α = \sqrt{number of visits to homeland country \times household size} and$$

$$β = \sqrt{household size \times household income} ,$$

where α and β define a height and a width of the culture cycle model. Each of the members of the ethnic group is assigned to one of a plurality of age groups based on the age of the member, and a quantity of the members of the ethnic group belonging to each of the age groups defines a thickness of the culture cycle model at each of the plurality of life stages of the members. In other embodiments, the method further includes the step of selecting a language of the advertisements between English and the native language associated with the ethnic group based on the identified at least one of the life stages of the culture cycle model to which the potential consumers of the product belong.

In yet other embodiments of the present invention, a system for directing advertisements to potential consumers of a product is disclosed, in which the consumers are a subset of members of an ethnic group associated with a homeland country and a native language. The system includes one or more processors, and processing logic executable by the one or more processors to perform the steps of retrieving information data associated with the members of the ethnic group, the information data comprising an age, a household size, a household income, a number of visits to the homeland country for each of the members; and generating a culture cycle model for the ethnic group representing a plurality of life stages of the members including at least college, marriage, parenting, and identity based on the information data associated with the members of the ethnic group using formulas

$$α = \sqrt{number of visits to homeland country \times household size} and$$

$$β = \sqrt{household size \times household income} ,$$

where α and β define a height and a width of the culture cycle model, and further where each of the members is assigned to one of a plurality of age groups based on the age of the member, and a quantity of the members belonging to each of the age groups defines a thickness of the culture cycle model at each of the plurality of life stages of the ethnic group. The processing logic further performs the steps of identifying in the culture cycle model at least one of the plurality of life stages to which the potential consumers of the product belong; determining characteristics of the advertisements to be directed to the potential consumers of the product based on the identified at least one of the life stages of the culture cycle model to which the potential consumers belong, wherein the determined characteristics include a language of the advertisements; and directing advertisements in the determined language to the potential consumers of the product.

In particular embodiments, the selected language of the advertisements is English if the identified at least one of the life stages of the culture cycle model to which the potential consumers belong is college, marriage, or parenting, and the selected language of the advertisements is the native language of the ethnic group if the identified at least one of the life stages of the culture cycle model to which the potential consumers belong is identity.

Other features and advantages of the invention will become apparent from the following detailed description, taken in conjunction with the accompanying drawings that illustrate, by way of example, various features of embodiments of the invention.

### BRIEF DESCRIPTION OF THE DRAWINGS

A detailed description of embodiments of the invention will be made with reference to the accompanying drawings, wherein like numerals designate corresponding parts in the several figures.

FIG. 1 illustrates the typical life cycle of a member of an ethnic group in accordance with an embodiment of the present invention.

FIG. 2 illustrates a life cycle for multicultural members of an ethnic group in accordance with an embodiment of the present invention.

FIG. 3 represents another life cycle for multicultural members of an ethnic group in accordance with an embodiment of the present invention.

FIG. 4 illustrates the CLAB Cycle™ modeling tool in accordance with an embodiment of the present invention.

FIG. 5 illustrates an example set of data used to generate the CLAB Cycle modeling tool in FIG. 4.

FIGS. 6a-6e show the resulting CLAB Cycle models for Korean-Americans, Vietnamese-Americans, Chinese-Americans, Indian-Americans, and Filipino-Americans respectively in accordance with an embodiment of the present invention.

FIGS. 7a-7b show examples of how the CLAB Cycle tool can be used to match products with potential consumers in accordance with an embodiment of the present invention.

FIG. 8 illustrates how consumers' mobile devices and geofencing can be used to collect data in accordance with an embodiment of the present invention.

FIG. 9 is a block diagram illustrating a system for delivering targeted advertising in accordance with an embodiment of the present invention

FIG. 10 is a block diagram illustrating an environment for operating a mobile device and delivering targeted advertising to the mobile device in accordance with an embodiment of the present invention.

FIG. 11 is a block diagram illustrating a network-based system within which targeted advertising can operate in accordance with an embodiment of the present invention.

FIG. 12 illustrates a method for directing advertisements to potential multicultural consumers of a product in accordance with an embodiment of the present invention.

FIG. 13 illustrates a method for directing advertisements to potential multicultural consumers of a product in accordance with an embodiment of the present invention.

### DETAILED DESCRIPTION OF THE INVENTION

As shown in the drawings for purposes of illustration, the invention is embodied in methods and systems for collecting and processing population, household characteristic, cultural, and/or other data, and in particular, such methods and systems for providing a culture, language, and behavior cycle (CLAB Cycle™) tool based on such data that is useful for targeting advertisements to multicultural consumers based on their life stage within the cycle as well as location-related data from the consumers' mobile devices and geofencing. The illustrated methods and systems provide a CLAB Cycle tool that is particularly useful for targeting advertisements to Asian-American consumers. However, it is to be understood that the tool may be adapted for targeting other multicultural consumers, such as Hispanic-Americans or African-Americans, or other ethnicities living in foreign countries, such as Vietnamese or Laotians living in South Korea.

As an example, based on U.S. Census and Scarborough data, the CLAB Cycle™ tool can be utilized to target different ethnic groups and determine the best way to reach multicultural consumers, such as Asian-Americans who are experiencing both their native Asian culture and American culture at critical stages of life within the cycle, such as college, getting married, having children, having grandchildren, and the like. By identifying the life stage in the cycle for potential consumers of a product being advertised, culturally relevant advertising can be created and directed to potential consumers. Further, by combining with Geoscape's Asianicity™ model, potential consumers can be reached via targeted media channels.

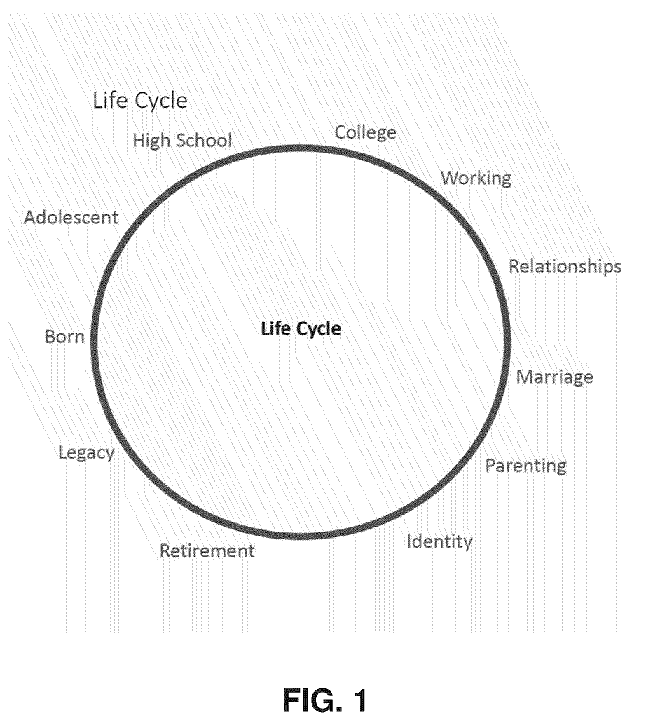

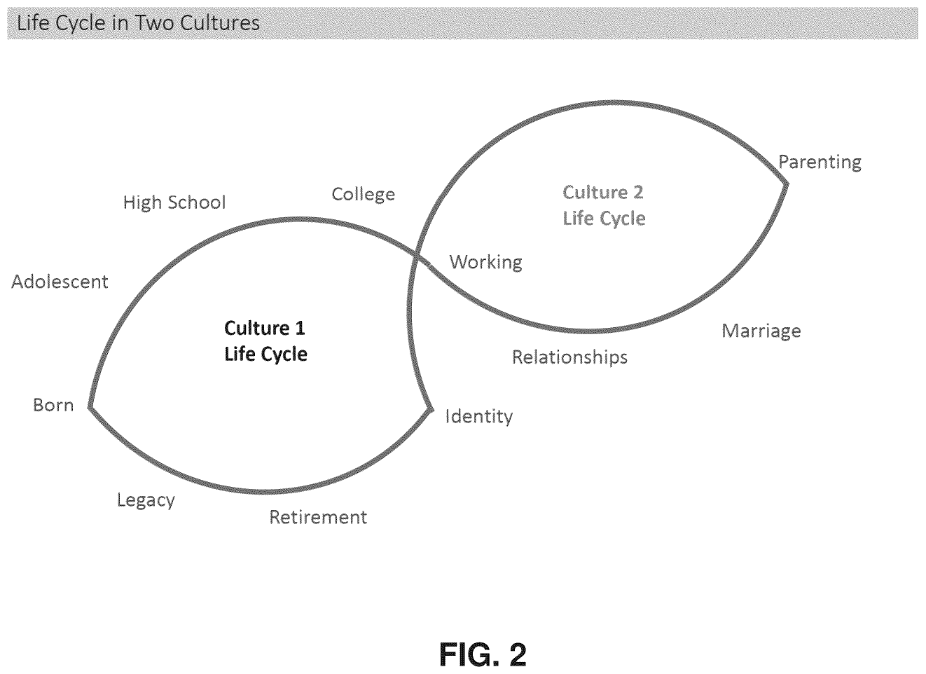

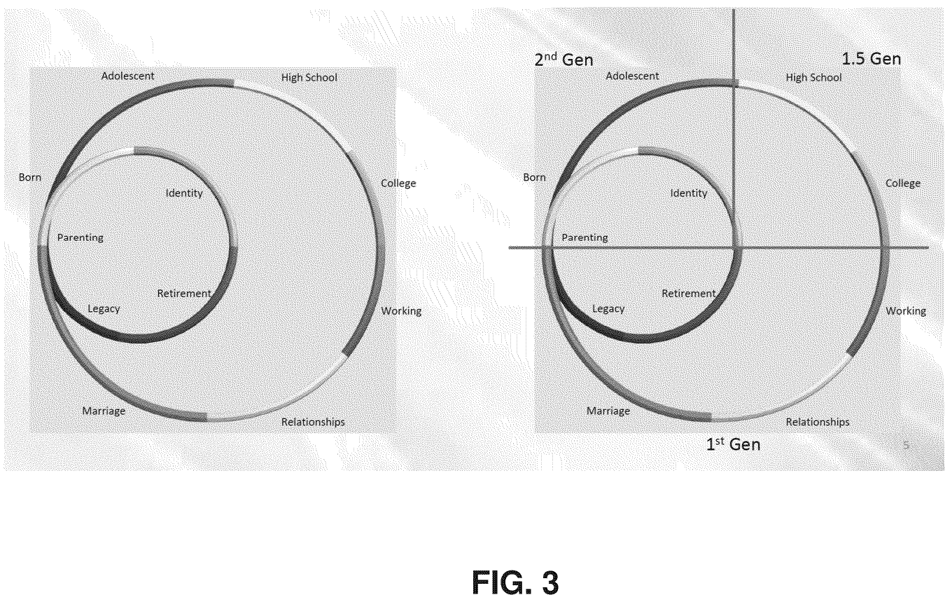

FIG. 1 illustrates the typical life cycle of a member of an ethnic group, starting at birth and proceeding clockwise through adolescence, high school, college, working, relationships, marriage, parenting, identity, retirement, and legacy. FIG. 2 illustrates a more detailed life cycle for multicultural members of an ethnic group, where Culture 1 represents life stages in a first country or culture, and Culture 2 represents life stages in a second country or culture. FIG. 2 represents how the life cycle of such multicultural members of the ethnic group has been traditionally understood. For example, for an Asian-American, Culture 1 represents the person's life either living in their native Asian country or being raised in an Asian cultural household, and Culture 2 represents the person's life living in the United States and acculturating to American life. The disadvantage of the cycle illustrated in FIG. 2 is that multicultural members of an ethnic group or their descendants, such as Asian-Americans, often acculturate to American life, and yet, while they do not physically return to their native Asian country, they sometimes return to aspects of their native Asian culture at critical stages of life (e.g., college, marriage, parenting), and thus, begin to experience both their native Asian culture and American culture simultaneously. FIG. 3 represents a better way to think of multicultural assimilation—rather than two separate circles in FIG. 2, but one circle within another circle in FIG. 3. As a result, the CLAB Cycle tool shown in FIG. 3 was created to better illustrate the multicultural experiences of members of an ethnic group, such as Asians/Asian-Americans (1^{st} generation or 1.5 generation), and/or their descendants born in the United States (2^{nd} generation). FIG. 3 shows that 1.5 generation and 2^{nd} generation Asian-Americans typically progress away from their native Asian culture and acculturate to American life as they move from adolescence through high school, college, and working life, but as they progress through relationships, marriage, and parenting/family, they often return to their native Asian culture and then continue in their native Asian culture through identity, retirement, and legacy. For example, Korean-Americans who are raised in Korean cultural households often acculturate to American life through high school, college, and working life, but as they progress through marriage and parenting/family, they often return to their Korean culture, for example, as Korean grandparents interact with their grandchildren, giving rise to multigenerational households.

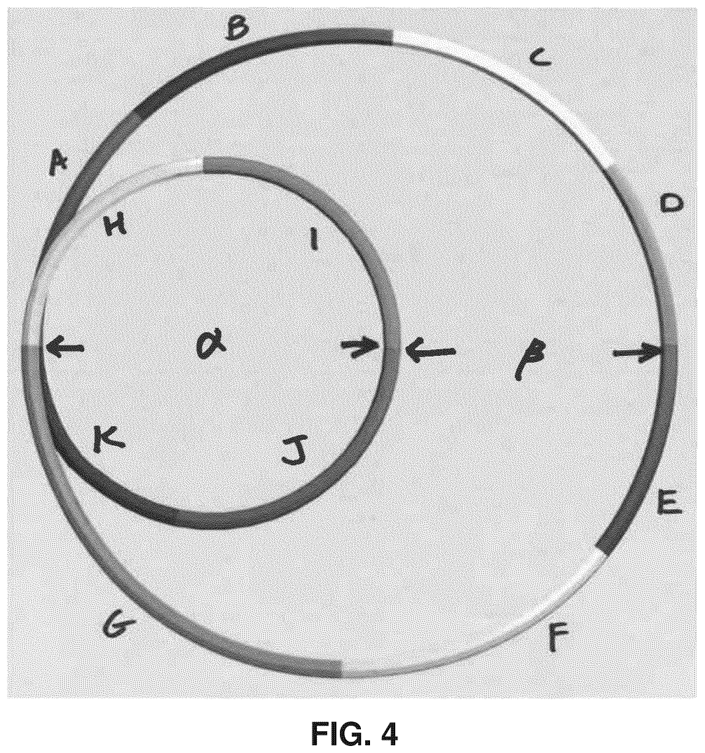

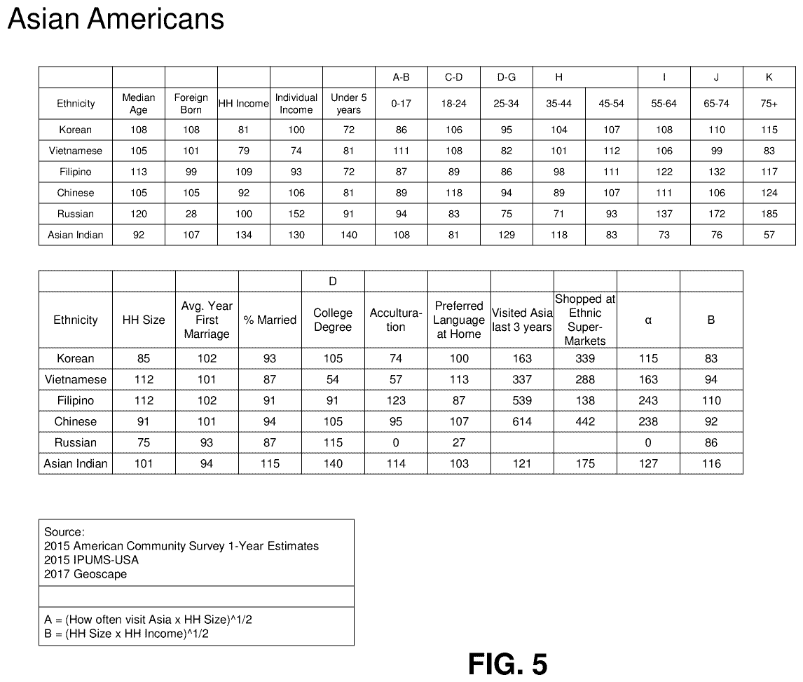

FIG. 4 illustrates the CLAB Cycle™ tool and an example set of corresponding data in FIG. 5. The data shown in FIG. 5 includes multicultural data sets from U.S. Census data, Claritas, Scarborough, and Geoscape's Asianicity™ model. Multiple data sets were used because some data sets did not have the desired data. The specific desired data ties consumers' behavior to their culture, i.e., how often do they shop at ethnic grocery stores, how often do they travel back to their homeland country in Asia, preferred language spoken at home, household size, and household income. These data are indicators of how closely they keep their native Asian culture within their family. Once these data sets are defined, the data is compared to the average and an index of 100 is used to determine the variation on the various three dimensional models based on the CLAB Cycle tool shown in FIG. 4. For the model, the life cycle stage population determines the thickness of the model. For example, in the illustrated embodiment referring to FIGS. 4 and 5, the groups A-K correspond to the life cycle stages in FIG. 3 and the population data for the age groups in FIG. 5. Groups A and B correspond to the life cycle stages of birth and adolescence respectively and the age group of 0-17 years old. Groups C and D correspond to the life cycle stages of high school and college respectively and the age group of 18-24 years old. Groups D-G correspond to the life cycle stages of college, working, relationships, and marriage respectively and the age group of 25-34 years old. Group H corresponds to the life stage of parenting and the age groups of 35-44 and 45-54 years old. Group I corresponds to the life stage of identity and the age group of 55-64 years old. Group J corresponds to the life stage of retirement and the age group of 65-74 years old. Group K corresponds to the life stage of legacy and the age group of 75 years old and up. In this embodiment, there is some overlap between life cycle stages and age groups, partially due to the age groups defined by and made available in various data sets. In alternative embodiments, the correspondence between the life cycle stages and age groups may be different, depending on the available data sets.

Referring to FIGS. 4 and 5, the width and the height of the model are determined by the variables a and B. Variable a is calculated based on the data “Visited Asia last 3 years” (i.e., how often people visited their homeland country in Asia) and “HH size” (i.e., household size).

$$α = \sqrt{Visited Asia last 3 years \times HH size}$$

Variable β is calculated based on the data “HH size” (i.e., household size) and “HH income” (i.e., household income).

$$β = \sqrt{HH size \times HH income}$$

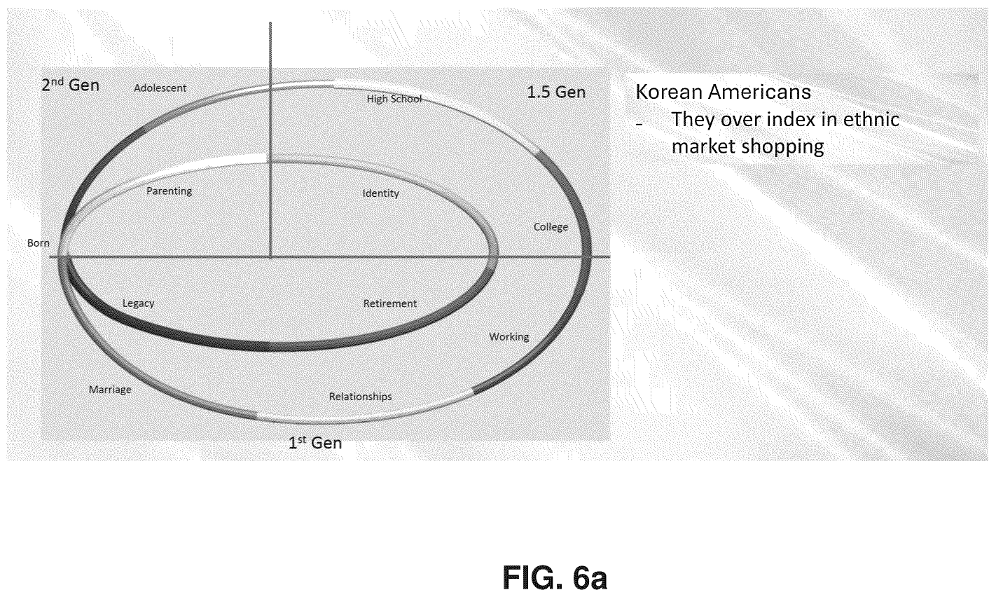

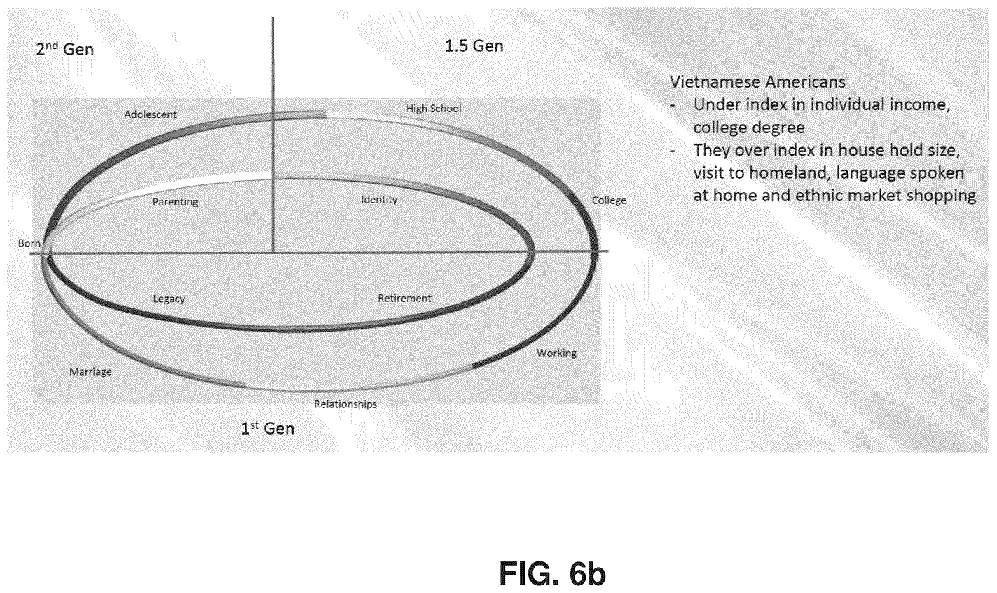

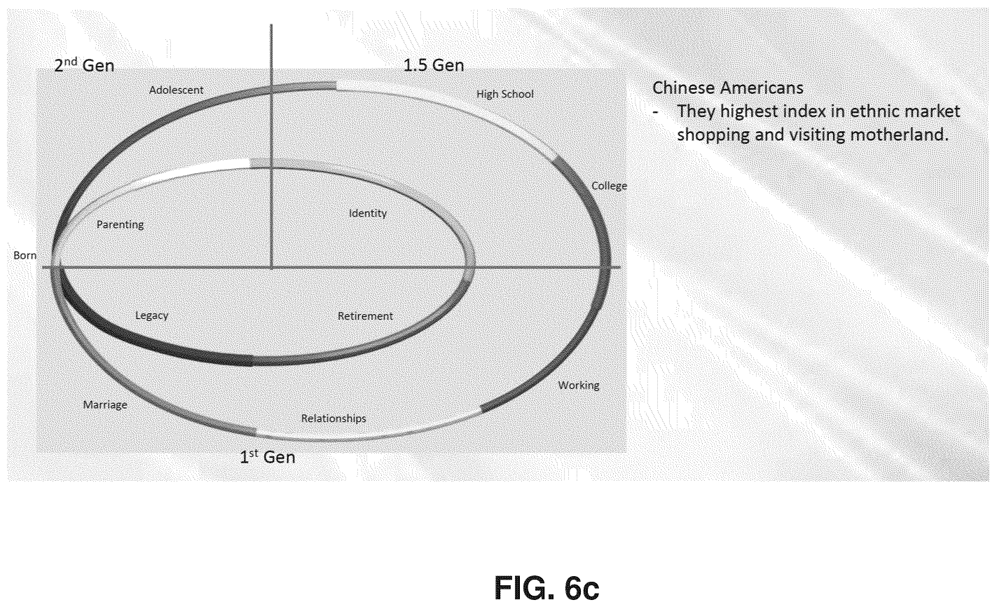

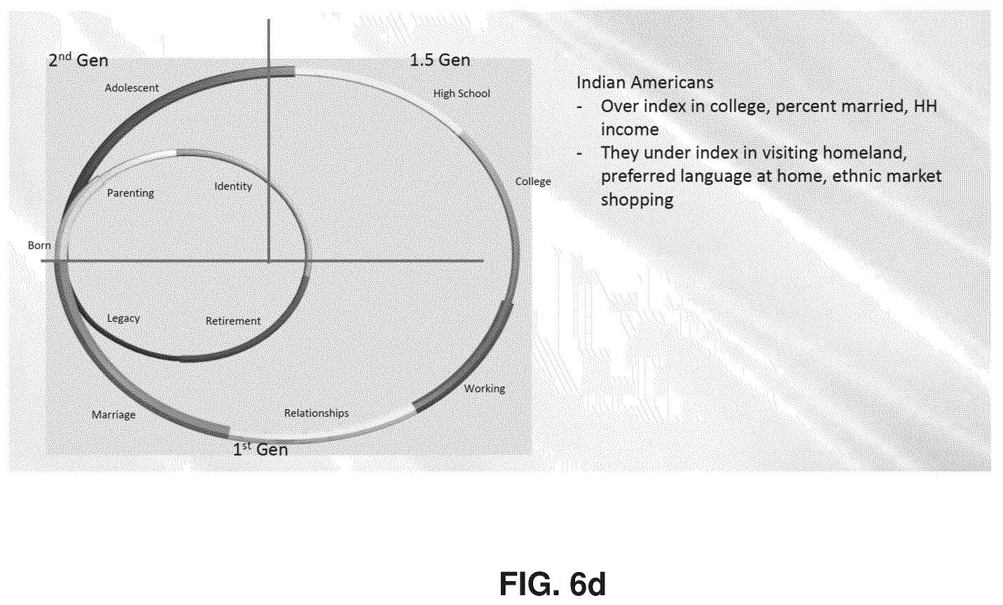

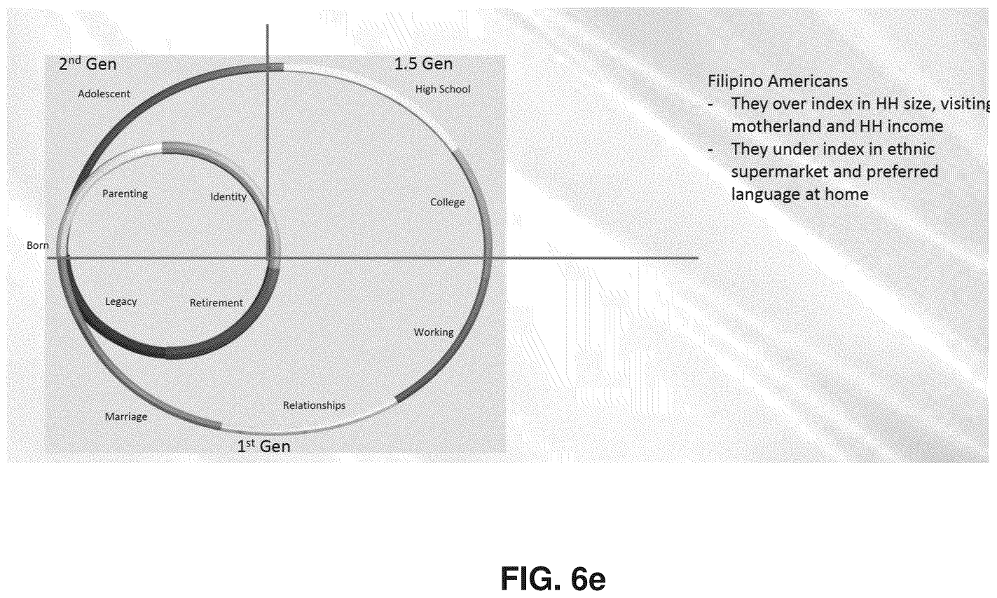

FIGS. 6a-6e show the resulting models for Korean-Americans, Vietnamese-Americans, Chinese-Americans, Indian-Americans, and Filipino-Americans, respectively. Generally speaking, the closer the model resembles a circle within a circle as in FIG. 4, the model illustrates that particular ethnicity becomes and remains more acculturated to American life as they progress through different stages of life. If the model looks more like an oval within an oval (or squished), the model illustrates that particular ethnicity returns more to or experiences more of their native Asian culture as they progress through critical stages of life, such as college, marriage, parenting/having children, and identity/having grandchildren, etc. In other words, they may grow more, and then become less, acculturated to American life as they progress through life. By knowing what stage a potential consumer is within the cycle, targeted marketing can engage with them by delivering an emotionally and culturally relevant message at the right touchpoint, including considering the appropriate language to be used in any such message.

As shown in the illustrated embodiments, FIG. 6a generally shows that Koreans/Korean-Americans may become and remain more acculturated to American life as they progress from birth to marriage, but may then grow less acculturated as they progress from parenting to legacy. For example, Korean-Americans may prefer to communicate in English only as they progress from birth to marriage, but then may grow more comfortable with communicating in English and Korean as they progress from parenting to legacy, particularly as elderly parents interact with grandchildren, giving rise to multigenerational households. Similar developments may be observed for Vietnamese-Americans and Chinese-Americans as shown in FIGS. 6b and 6c respectively. FIGS. 6d and 6e illustrate slightly different developments for Indian-Americans and Filipino-Americans. Instead of growing less acculturated to American life as they progress from parenting to legacy, the models show that Indian-Americans and Filipino-Americans remain more acculturated to American life as they progress through their lives. As a result, for example, Indian-Americans and Filipino-Americans may grow and remain comfortable with communicating in English and their native languages, or even prefer communicating in English only, as they progress through their lives.

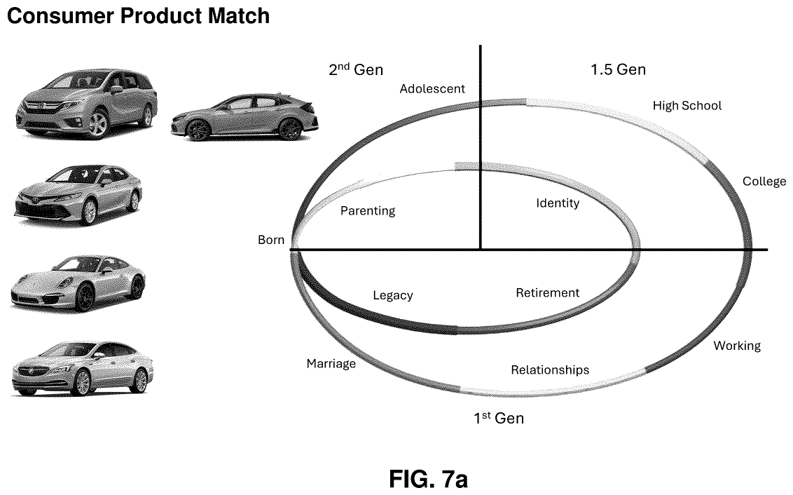

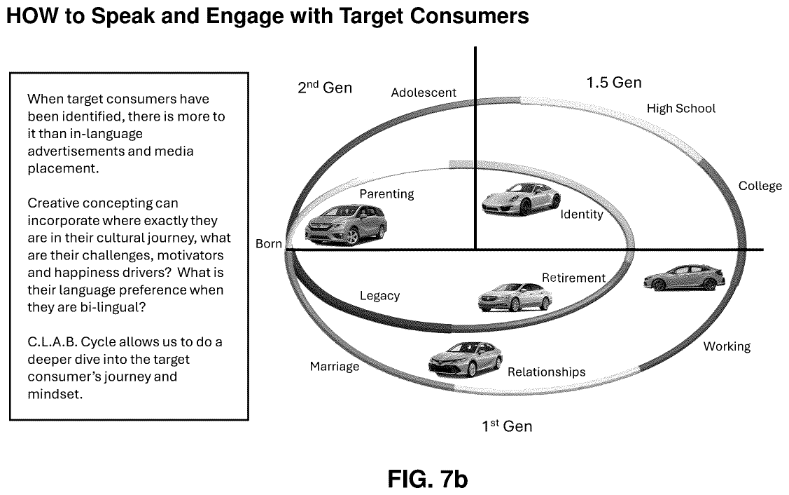

FIGS. 7a-7b show examples of how the CLAB Cycle tool can be used to match products with consumers and how to speak and engage with potential consumers. When potential consumers have been identified, more is required than simply advertisements in their native language and media placement. For example, when potential consumers are 2nd generation Korean-Americans in the college or marriage life cycle stages, delivering advertisements to them in their native Korean language may not be effective because such Korean-Americans may prefer using the English language and/or may not understand much of the Korean language. Creative concepting can incorporate where exactly they are in their cultural journey, considering their challenges, motivators and happiness drivers, as well as their language preference when they are bilingual. The CLAB Cycle tool enables a deeper dive into the potential consumer's journey and mindset. For example, the tool can be used to match the basic or compact sedan with a consumer in the college or working stage of life, the full-size sedan with a consumer in the relationships or marriage stage of life, the minivan with a consumer in the parenting stage of life, the sports car with a consumer in the identity stage (i.e., possible mid-life crisis between parenting and retirement), and the luxury sedan with a consumer in the retirement stage of life. Further, the tool can be used to determine whether to target the consumer with advertising in English or their native Asian language. As an example, advertising directed to the consumers in the college, working, relationships, marriage, and/or parenting stages of life may be in the English language, while advertising directed to consumers in the identity, retirement, and/or legacy stages of life may be in their native Asian language or English, depending on developments shown in the culture cycle model for a particular ethnic group.

As described above, the CLAB Cycle tool can be used to target advertising to different ethnic groups and determine the best way to reach multicultural consumers who are experiencing both their native culture and American culture at critical stages of life. Location-based advertising, and particularly geofencing, can also be used to tie consumers' behavior to their culture.

Location-based marketing or advertising serves advertising based upon a person's current or previous location. It allows marketers to make meaningful contact with their intended customers and improve the customer experience. Geofencing is one type of location-based advertising. It involves creating a virtual barrier around a location, which can be a radius around a large location or a specific building footprint. Advertising can be served to a person with a mobile phone when the person enters the virtual barrier or geofence with their mobile phone. They may receive an alert, push notification, or an ad within a mobile app based upon that current location. Location-based audiences can also be reached on Facebook, Instagram, Snapchat, and Twitter through the social media apps' own targeting tools, or by uploading a list of mobile advertising IDs or device identifiers as a custom audience to match on third party programmatic advertising platforms.

The primary data used to create a location-based audience is GPS data collected by mobile apps. This data takes the form of latitude/longitude coordinates that is then matched to a real-world point of interest and can then be converted into audience segments. Points-of-interest are business and retail locations, not home addresses. Other data signals that can be used for location include Bluetooth beacons, IP addresses and WiFi networks in order to determine location. As is the case with all location data, a person must grant permission to an app to share this information.

To match location data to a mobile device, app publishers and their advertising partners may use a specific identifier for collecting data for the purposes of advertising and product improvement. The industry uses the term Mobile Advertising ID (MAID, for short). Apple calls their identifier the IDFA, or Identifier for Advertising. Google's identifier is the AAID, or Android Advertising Identifier. MAIDs are a different identifier than the device's ID that the manufacturer assigns to the phone. The user can reset the MAID on their phone at any time, but cannot reset their actual device ID.

In embodiments of the present invention, location-based data may be gathered from mobiles devices, such as smart phones, and stored in a database. Typically, a user of a mobile device installs an app on their mobile device that collects location data. The user gives the app permission to use their location and share this data with third parties. Third party providers collect the device identifier (e.g., typically the MAID, but the device ID is also possible) for the mobile device along with the location and timestamp from the opted-in mobile device. The third party provider then anonymizes and aggregates the location data so it cannot be tied back to any specific individual or personally identifiable information in compliance with privacy laws and regulations. The third party provider matches the device's location data to places, such as stores, restaurants, theaters, concert venues, stadiums, auto dealerships, and the like. Based on the location, the user becomes part of audience categories. This anonymized and aggregated audience data is made available to customers, such as advertisers, who can use the device identifiers to advertise to audiences based on places they have visited. The data may flow from the database to an application server, which may provide a service via an API, or a web server, which may provide a service via a web interface such as a web browser.

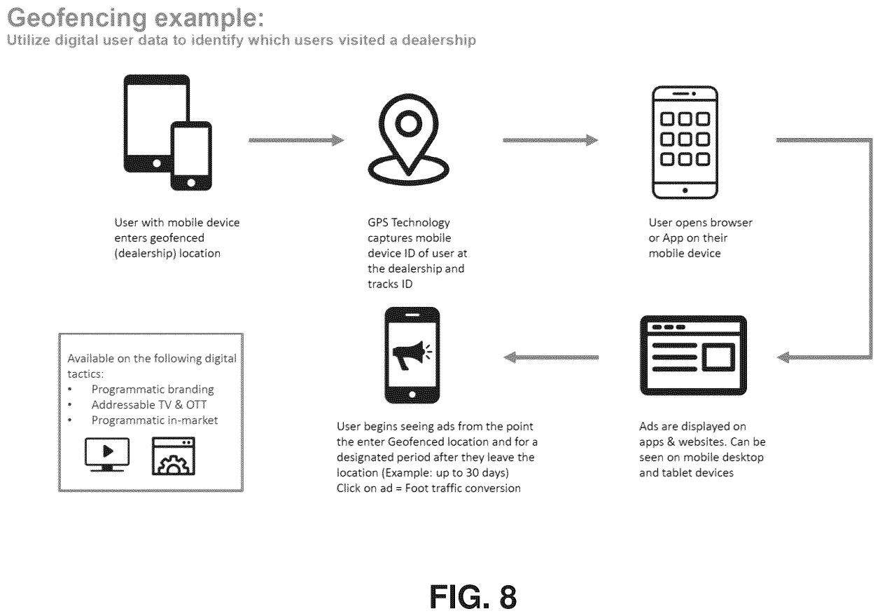

FIG. 8 illustrates how consumers' mobile devices and geofencing can be used to collect data not otherwise readily available in public data sources or packaged datasets. When a consumer enters a geofenced location (e.g., car dealership), the consumer's mobile device ID can be captured as being at the dealership, and then targeted advertising can be displayed to the consumer relevant to the car and/or dealership for a certain period of time. For example, when a consumer enters a geofenced location, such as an English-speaking service or a Korean-speaking service at a Korean-American church, the consumer's mobile device ID can be captured as being at the English or Korean service, and then targeted advertising can be displayed to the consumer. For example, if the consumer's mobile device ID is captured as being at the Korean service, then targeted advertising in the Korean language can be displayed to the consumer.

Various companies provide geofencing marketing platforms that enable marketing agencies to deliver advertising to potential consumers. The following description and accompanying drawings provide details on particular embodiments of the operational environment for methods and systems of providing a culture, language, and behavior cycle tool that is useful for targeting advertisements to multicultural consumers. However, it will be evident to one skilled in the art that the present systems and methods may be practiced with modifications to particular embodiments of the operational environment, and may include other examples or details not specifically discussed.

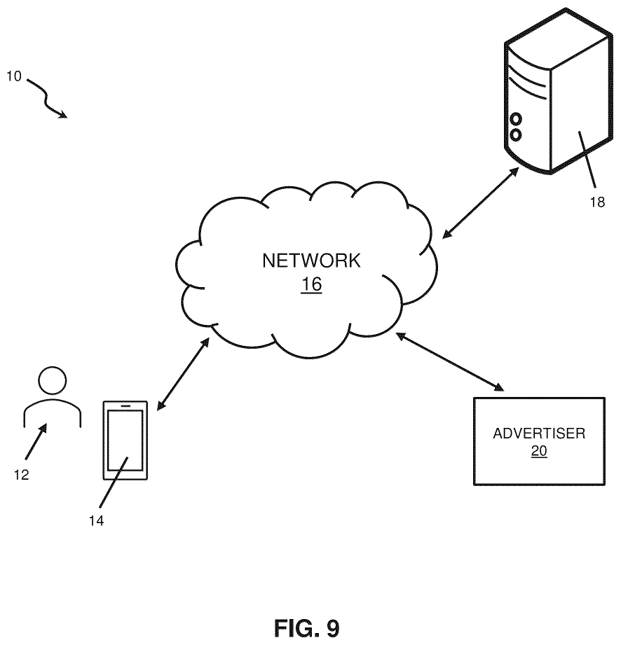

FIG. 9 is a block diagram illustrating a system 10 for delivering targeted advertising in accordance with an embodiment of the present invention. The system 10 includes a user 12 (representative of any number of users), a network-based publication system 18, and an advertiser 20 that can connect to and communicate with one another through a network 16. The user 12 connects to and interacts with the network-based publication system 18 via a mobile device 14 (e.g., smart phone, PDA, laptop, or similar mobile electronic device capable of some form of data connectivity). The advertiser 20 can operate computer systems for processing ethnic group data as well as location-based data to determine characteristics of culturally relevant targeted advertisements, defining geofences, and creating such targeted advertisements. The advertiser 20 can also operate computer systems for receiving ethnic group and/or location-based data from third party provider(s) (not shown) through the network 16 as well as defining geofences and/or delivering the targeted advertisements to the user(s) 12 utilizing third party platform(s) (not shown) through the network 16. The network-based publication system 18 can interact with any of the systems, including third party platforms (not shown), used by the advertiser 20 for operation of the advertiser's business. For example, the network-based publication system 18 can distribute and monitor targeted advertising delivered on behalf of the advertiser 20. The network-based publication system 18 can receive location data from the mobile device 14 of the user 12 (as well as the mobile devices 14 of other users 12) to determine whether the user(s) 12 should receive advertising published by the network-based publication system 18 based on the location of the mobile device(s) 14 of the user(s) 12.

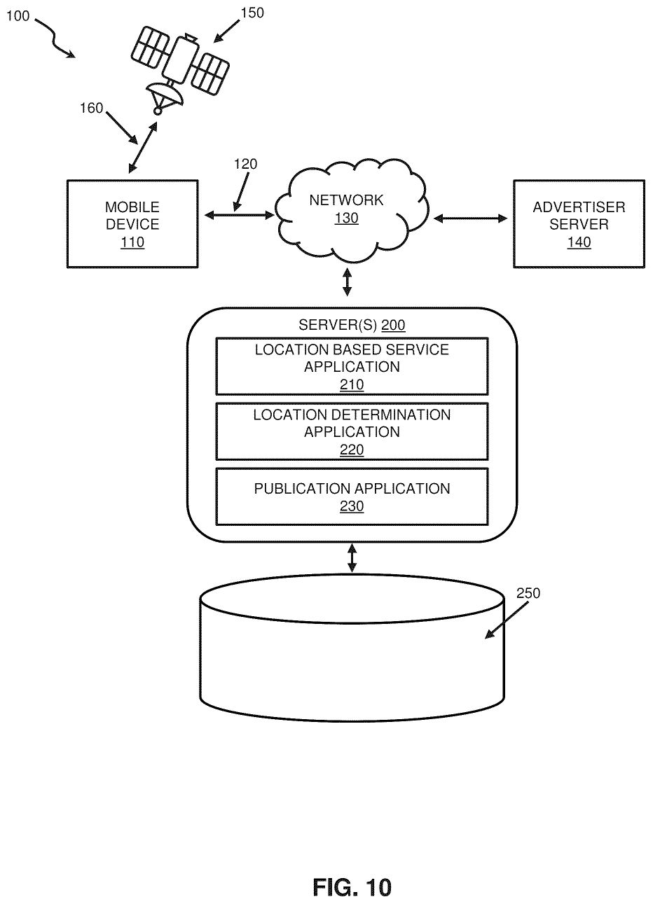

FIG. 10 is a block diagram illustrating an environment 100 for operating a mobile device and delivering targeted advertising to the mobile device in accordance with an embodiment of the present invention. The environment 100 includes a mobile device 110, a communication connection 120, a network 130, an advertiser server 140, a communication satellite 150, a satellite connection 160, server(s) 200, and a database 250. The servers 200 can optionally include location-based service application 210, location determination application 220, and publication application 230. The database 250 can include data relating to potential consumers and ethnic groups, device identifiers of mobile devices, location histories for mobile devices, geofenced locations, and/or advertisements to be directed to potential consumers. The mobile device 110 represents any type of mobile device that can be used to receive advertisements, such as a cellular telephone or smart phone, a personal digital assistant (PDA), a Personal Navigation Device (PND), a handheld computer, a tablet computer, a notebook computer, or other type of portable device. The mobile device 110 may interface via a connection 120 with a communication network 130. Depending on the type of mobile device 110, different types of connections 120 and communication networks 130 may be used.

For example, the connection 120 may be a Code Division Multiple Access (CDMA) connection, a Global System for Mobile communications (GSM) connection, or other type of cellular connection, and may utilize various types of data transfer technology, such as 3G, 4G, 4G LTE, or 5G wireless networks, or other data transfer technology. The communication network 130 may include a cellular network that has a plurality of cell sites of overlapping geographic coverage, interconnected by cellular telephone exchanges, which may be coupled to a network backbone. The connection 120 may be other types of wireless connections, such as Wi-Fi, Bluetooth, NFC, or the like. In such an embodiment, the communication network 130 may include one or more wireless access points coupled to a local area network (LAN), a wide area network (WAN), the Internet, or other data network. Further, the connection 120 may be a wired connection, for example an Ethernet link, and the communication network 130 may be a LAN, a WAN, the Internet, or other data network. Accordingly, a variety of different configurations are contemplated.

A plurality of servers 200 may be coupled via interfaces to the communication network 130, for example, via wired or wireless interfaces. These servers 200 may be configured to provide various types of services to the mobile device 110. Also, some or all of the services provided by the servers 200 may be operated by the advertiser or third party provider through third party platform(s). For example, one or more servers 200 may execute location-based service (LBS) applications 210, which interoperate with software executing on the mobile device 110, to provide LBS applications to a user. LBS applications can use knowledge of the mobile device's location and/or the location of other mobile devices to provide location-specific information, recommendations, notifications, interactive capabilities, and/or other functionality to a user. For example, an LBS application 210 can provide location data to a network-based publication system 18 (FIG. 1), which can then be used to assist in delivering advertisements relevant to the user's current location. Knowledge of the device's location and/or the location of other devices may be obtained through interoperation of the mobile device 110 with a location determination application 220 executing on one or more of the servers 200. Location information may also be provided by the mobile device 110 without use of a location determination application. In some examples, the servers 200 can also include publication application 230 for providing targeted advertisements based on geofence enabled advertising campaigns. In certain examples, location data can be provided to the publication application 230 by the location determination application 220. In some examples, the location data provided by the location determination application 220 can include geofencing, merchant, or building information (e.g., identification of geofenced location, store location, or building type and location). In certain examples, the location determination application 220 can receive signals via the network 130 to further identify a location. For example, an advertiser, third party provider, or merchant may broadcast a specific IEEE 802.11 service set identifier (SSID) that can be interpreted by the location determination application 220 to identify a particular retail location. In another example, the advertiser, third party provider, or merchant may broadcast an identification signal via radio-frequency identification (RFID), near-field communication (NFC), or a similar protocol that can be used by the location determination application 220. The advertiser server 140 can be utilized to interact with the mobile device 110 and the servers 200 to provide various functions, such as receiving and processing consumer and ethnic group information data, defining geofenced locations, creating and directing targeted advertising to potential consumers, and the like.

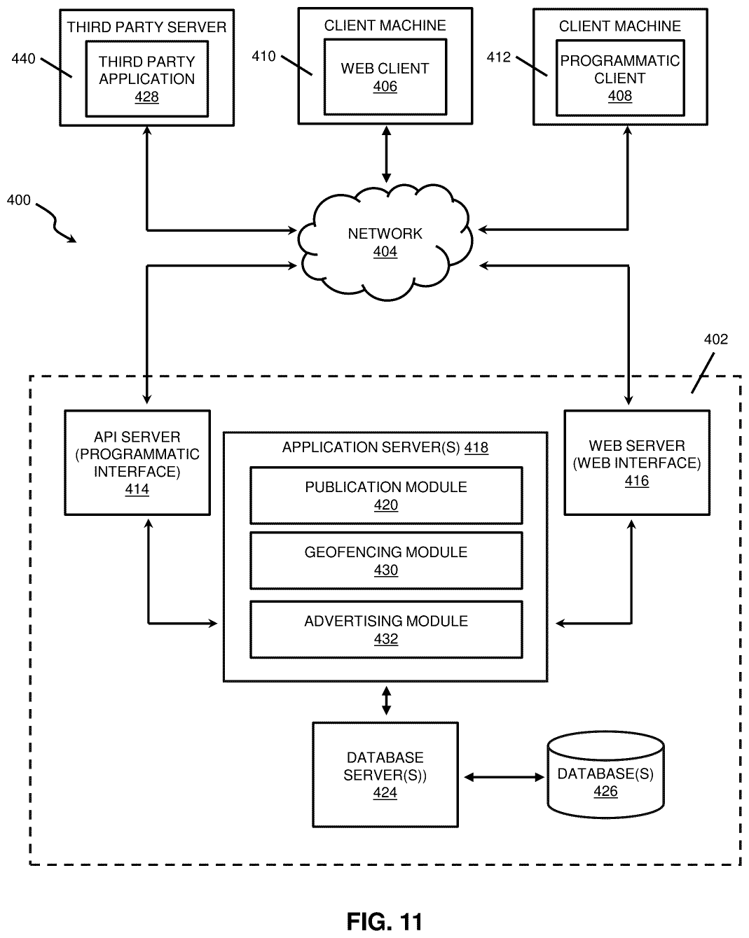

FIG. 11 is a block diagram illustrating a network-based system 400 within which targeted advertising can operate (in the exemplary form of a client-server system) according to an embodiment of the present invention. A networked system 402 is shown in the example form of a network-based location-aware publication that provides server-side functionality via a network 404 (e.g., the Internet or WAN) to one or more client machines 410 and 412. FIG. 11 illustrates, for example, a web client 406 (e.g., a browser, such as the Internet browser Microsoft Edge, Apple Safari, Google Chrome, Firefox, or the like) and a programmatic client 408 such as a mobile phone application executing on respective client machines 410 and 412. In one embodiment, the client machines 410 and/or 412 can be in the form of a mobile device, such as mobile device or tablet 110. In other embodiments, the client machines 410 and/or 412 can be a personal computing system, such as a laptop or desktop computer.

An Application Programming Interface (API) server 414 and a web server 416 are coupled to, and provide programmatic and web interfaces respectively to, one or more application servers 418. The application servers 418 host one or more publication modules 420 (e.g., commerce, advertising, and marketplace modules), geofencing modules 430, and advertising modules 432. The application servers 418 are, in turn, shown to be coupled to one or more database servers 424 that facilitate access to one or more databases 426. In some examples, the application server 418 can access the databases 426 directly without the need for a database server 424.

The publication module(s) 420 may provide a number of publication functions and services to users that access the networked system 402. Products (e.g., goods or services) may be advertised or made available via the various publication module(s) 420. The geofencing module(s) 430 may provide generation of and location detection within geofences. The advertising module(s) 432 may provide real-time, location-aware advertisements to users of the networked system 402 based on data from the geofencing module 430 or the database(s) 426. The geofencing module 430 and advertising modules 432 can be configured to use all of the various communication mechanisms provided by the networked system 402 to generate and detect geofenced locations relative to users and present advertisements to users. For example, the advertising modules 432 can provide advertisements to the publication modules 420 for delivery based on data from the geofencing module 430 and the database(s) 426. The advertisements can be personalized based on current location, time of day, user profile data, past purchase history, or recent physical or online behaviors recorded by the network-based system 400. The advertisements can be based on the user's location being within a defined geofence and can continue for a certain period of time after the user exits the geofenced location utilizing data from the geofencing module 430.

While the publication module(s) 420, geofencing module(s) 430, and advertising module(s) 432 are shown in FIG. 11 to all form part of the networked system 402, it will be appreciated that, in alternative embodiments, the geofencing module 430 and/or advertising module 432 may form a service separate and distinct from the networked system 402. Further, while the system 400 shown in FIG. 11 employs a client-server architecture, the present invention is of course not limited to such an architecture, and could equally well find application in a distributed, or peer-to-peer, architecture system, for example. The various publication modules 420, geofencing modules 430, and advertising modules 432 could also be implemented as standalone systems or software programs, which do not necessarily have networking capabilities.

The web client 406 accesses the various publication modules 420, geofencing modules 430, and advertising modules 432 via the web interface supported by the web server 416. Similarly, the programmatic client 408 accesses the various services and functions provided by the publication modules 420, geofencing modules 430, and advertising modules 432 via the programmatic interface provided by the API server 414. The programmatic client 408 may, for example, be a smart phone application.

FIG. 11 also illustrates a third party application 428, executing on a third party server machine 440, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more geofencing, advertising, or marketplace functions that are supported by the relevant applications of the networked system 402. Additionally, the third party website may provide merchants with access to the geofencing modules 430 and advertising modules 432 for advertising or marketing purposes.

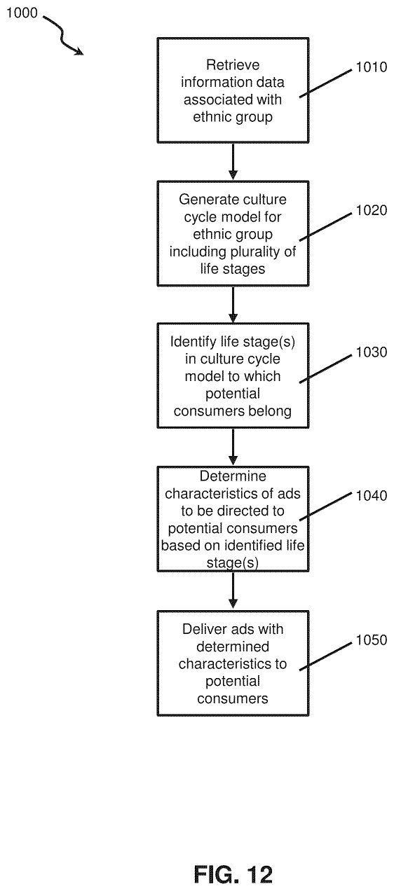

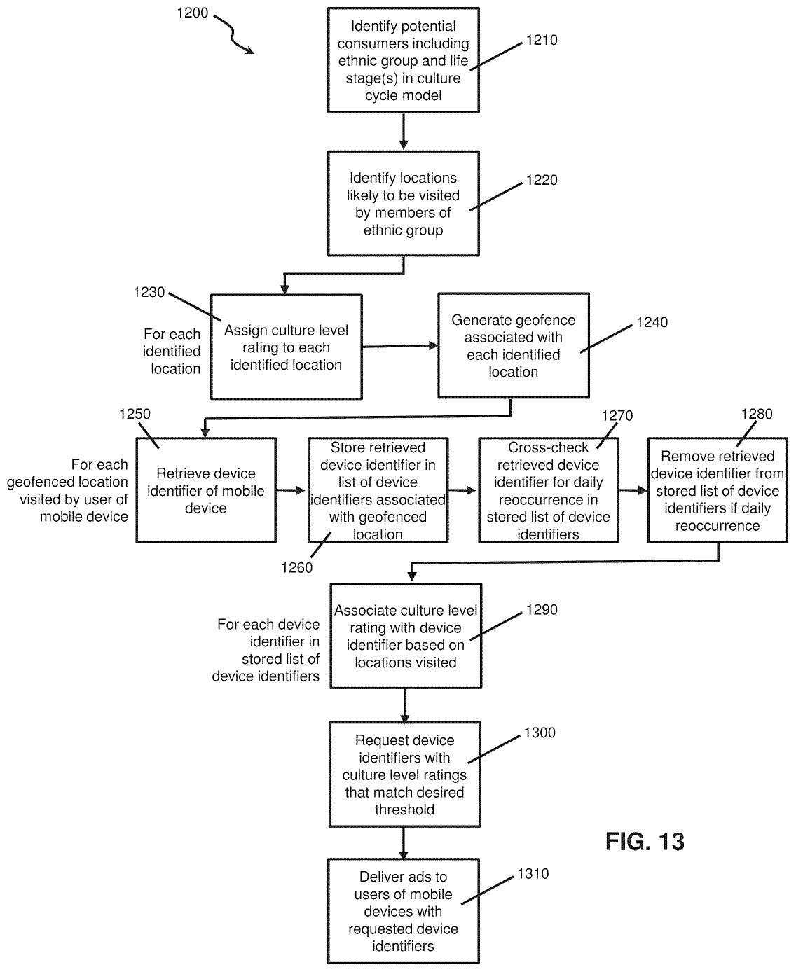

FIGS. 12 and 13 illustrate exemplary methods for directing advertisements to potential multicultural consumers of a product. Some portions of the methods may be performed by processing logic that may comprise hardware (e.g., dedicated logic, programmable logic, microcode, etc.), software (such as that which may be run on a general-purpose computer system or a dedicated machine), or a combination of both. In one embodiment, the methods 1000 and 1200 in FIGS. 12 and 13 illustrate exemplary interactions between a user of a mobile device 110 (or 14), a networked system 402 (e.g., network-based publication system 18), and an advertiser (e.g., advertiser 20) in generating a culture cycle model for an ethnic group, determining characteristics of advertisements to be directed to potential consumers who are members of the ethnic group, creating and then directing such advertisements to potential consumers on their mobile devices, particularly during and after visits to geofenced locations. Some portions of the methods may be performed by the various example modules discussed above, and each of the modules may comprise processing logic.

FIG. 12 is a flowchart illustrating a method 1000 for directing advertisements to potential consumers of a product in accordance with an embodiment of the present invention. The consumers belong to an ethnic group associated with a homeland country and a native language, and may be multicultural, experiencing both their native culture and American culture at different stages of life. At step 1010, information data associated with members of the ethnic group is retrieved. The information data may include data relating to the age, household size, household income, and number of visits to the homeland country for each of the members of the ethnic group. Other information data may include the marital status, highest education level/degree obtained, preferred language at home, number of shopping trips to ethnic grocery or other stores, and/or birth country (e.g., United States or foreign country) for each of the members of the ethnic group. At step 1020, a culture cycle model for the ethnic group including a plurality of life stages for the members is generated. The life stages may include birth, adolescence, high school, college, working, relationships such as dating and engagement, marriage, parenting, identity, retirement, and legacy. The culture model is generated using the formulas

$$α = \sqrt{number of visits to homeland country \times household size} and$$

$$β = \sqrt{household size \times household income} ,$$

wherein α and β define a height and a width of the culture cycle model. Further, the population numbers for each life stage define the thickness of the model. In other words, each member of the ethnic group is assigned to an age group based on the member's age, and a quantity of the members belonging to each age group defines the thickness of the model at each of the life stages. At step 1030, at least one of the life stages in the culture cycle model is identified to which potential consumers of the product belong. For example, potential consumers of a sports car may be identified as belonging to the working life stage while potential consumers of a minivan may be identified as belonging to the parenting life stage. It is possible that potential consumers may be identified as belonging to more than one of the life stages in the culture cycle model due to overlapping ages and life stages. For example, potential consumers of a sports car may be identified as belonging to the working, relationships, marriage, and/or parenting life stages in the culture cycle model. At step 1040, characteristics of the advertisements to be directed to the potential consumers of the product are determined based on the identified life stage(s) of the culture cycle model to which the potential consumers belong. The determined characteristics of the advertisements may include a language of the advertisements, selecting between English and the native language of the ethnic group. Other determined characteristics may include the imagery or scenarios depicted in the advertisements. At step 1050, advertisements with the determined characteristics, including the determined language, are delivered to the potential consumers of the product. For example, to promote the superiority of international entertainment packages to Japanese, Korean, Filipino, French and Italian audiences in a culturally relevant manner, advertisements can depict culturally authentic circumstances and scenarios taking place in the United States such as Saturday language schools (Korean, Japanese, French), popular food traditions and gatherings (Filipino boodle feast), or Sunday dinners with Nonna (Italian) to capture the authenticity of cultural

experiences. The advertising content can focus on the fact that a potential consumer does not have to feel lost and disconnected because home is just a remote away with superior international entertainment offerings. The content can also be delivered in the native language along with English subtitles in order to reach multicultural consumers. As described above, the CLAB Cycle tool can be used to target advertising to different ethnic groups and determine the best way to reach multicultural consumers who are experiencing both their native culture and American culture at critical stages of life. Location-based advertising, and particularly geofencing, can be used to tie consumers' behavior to their culture.

FIG. 13 is a flowchart illustrating a method 1200 for directing advertisements to potential consumers of a product utilizing geofencing in accordance with an embodiment of the present invention. The consumers belong to an ethnic group associated with a homeland country and a native language, and may be multicultural, experiencing both their native culture and American culture at different stages of life. At step 1210, using marketing data and the CLAB Cycle tool, potential consumers of the product, including their respective ethnic group and life stage in the CLAB Cycle, are identified. For example, if the product is handwarmers being offered for sale, marketing data may indicate that Korean/Korean-American women in their 50s are frequent buyers of the handwarmers. Using the CLAB Cycle tool, such Korean/Korean-American women may be identified as being in the parenting and/or identity stages of the cycle, during which such Korean/Korean-American women may experience both American culture and their native Korean culture. With this in mind, at step 1220, locations that members of the ethnic group typically or are likely to visit, such as Korean language schools, restaurants, medical facilities, buildings, and/or offices, that are used by Korean/Korean-Americans are identified. At step 1230, these locations are categorized or assigned a culture level rating. The culture level rating indicates a likelihood or frequency that the location is visited by members of the particular ethnic group; in other words, how “cultural” or “ethnic” the location is considered. For example, a Korean clinic/doctor, particularly with Korean-speaking personnel, or a Korean language school may be given a high culture level rating (e.g., 9 or 10 points rating on a 10-point rating scale), while an Asian market that is frequented by multiple Asian populations including Korean, Chinese, Japanese, and the like, such as H-Mart, may be given a medium culture level rating (e.g., 5 points rating on a 10-point rating scale). At step 1240, a geofence is generated to be associated with each of these identified locations. At step 1250, when a mobile device for a user is detected as entering the geofence associated with one of the identified locations, the device identifier assigned to the mobile device is retrieved, and at step 1260, the retrieved device identifier is stored in a list of device identifiers assigned to mobile devices that have entered the geofence associated with one of the identified locations. At step 1270, the retrieved device identifier is cross-checked for generally daily reoccurrence in the stored list of device identifiers associated with one of the identified locations, and at step 1280, the retrieved device identifier is removed from the stored list of device identifiers if it reoccurs in the stored list on a generally daily basis. Such steps account for people who are staff or workers at the location, and remove the respective device identifiers of their mobile devices from the stored list of device identifiers associated with one of the identified locations. At step 1290, a culture level rating of the mobile device is determined and then associated with the retrieved device identifier. The culture level rating of the mobile device may be based upon the number of locations visited by the user and the culture level rating of each of the locations visited by the user. Higher weight is given to mobile devices that have visited more locations as well as visited locations with high culture level ratings. For example, a mobile device of a user who visits a Korean clinic, Korean language school, and Korean market would receive a high culture level rating. At step 1300, the device identifiers with culture level ratings that match a selected threshold corresponding to the respective stage in the CLAB Cycle of the potential consumers (from step 1210) are requested. For example, if the potential consumers are Korean-American women identified as being in the parenting and/or identity stages of the cycle, during which such Korean-American women may begin experiencing both American culture and a return to their native Korean culture, device identifiers with associated culture level ratings of above 7 points may be requested. At step 1310, advertisements are directed to users of the mobile devices with the requested device identifiers, both while at the geofenced location or for a certain period afterwards. Device identifiers may also be matched on third party programmatic advertising platforms to target the specific ethnic group. Typical third party programmatic advertising platforms deliver targeted ads using email addresses, phone numbers, device IDs, but do not account for ethnic groups. At best, such third party platforms can account for the language used on the phone. However, the CLAB Cycle tool and geofencing data can be utilized to more specifically identify the potential consumers. The device identifiers assigned to the mobile devices are typically the MAIDs assigned to the mobile devices, but may also be the device IDs or other identifying information.

In other embodiments of the present invention, geofencing may be utilized based on user lifestyle. A model of potential consumers is created based on a product or service to be promoted, and then locations that such potential consumers may visit are identified. Instead of examining the consumers' culture, lifestyle habits of the consumers are analyzed. For example, consumers who buy handwarmers typically go skiing or fishing. As a result, locations such as ski resorts or fishing lakes may be identified as locations that potential consumers may visit. The device identifiers associated with visits to such locations are then retrieved and cross checked to remove any device identifiers that reoccur on a generally daily basis, such as for mobile devices of staff or workers from that location. Then the device identifiers that match a selected threshold are requested, and these device identifiers are then matched on third party programmatic advertising platforms to target the specific consumers.

The advantage of the present invention is that the CLAB Cycle tool can be used to determine what stage a desired consumer is within the cycle, and then targeted marketing can be delivered to the consumer in an emotionally and culturally relevant manner. Also, culturally relevant data not otherwise readily available can be captured using consumers' mobile devices and geofencing.

While the description above refers to particular embodiments of the present invention, it will be understood that modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for directing advertisements to potential consumers of a product, the consumers being a subset of members of an ethnic group associated with a homeland country and a native language, comprising:
retrieving information data associated with the members of the ethnic group, the information data comprising an age, a household size, a household income, and a number of visits to the homeland country for each of the members;
generating a culture cycle model for the ethnic group representing a plurality of life stages of the members based on the information data associated with the members of the ethnic group including the age, the household size, the household income, and the number of visits to the homeland country for each of the members;
identifying in the culture cycle model at least one of the plurality of life stages to which the potential consumers of the product belong;
determining characteristics of the advertisements to be directed to the potential consumers of the product based on the identified at least one of the life stages of the culture cycle model to which the potential consumers belong, wherein the determined characteristics include a language of the advertisements; and
directing advertisements with the determined characteristics including the determined language to the potential consumers of the product.

2. A method for directing advertisements of claim 1, wherein the culture cycle model for the ethnic group is generated using formulas
$$α = \sqrt{number of visits to homeland country \times household size} and$$
$$β = \sqrt{household size \times household income} ,$$
wherein α and β define a height and a width of the culture cycle model.

3. The method for directing advertisements of claim 2, wherein each of the members of the ethnic group is assigned to one of a plurality of age groups based on the age of the member, and a quantity of the members belonging to each of the age groups defines a thickness of the culture cycle model at each of the plurality of life stages of the members.

4. The method for directing advertisements of claim 1, wherein the determining characteristics of the advertisements step further comprises choosing between English and the native language associated with the ethnic group as the language of the advertisements.

5. The method for directing advertisements of claim 1, wherein the plurality of life stages represented in the culture cycle model include at least college, marriage, parenting, and identity.

6. The method for directing advertisements of claim 5, wherein the determined language of the advertisements is English if the identified at least one of the life stages of the culture cycle model to which the potential consumers belong is college, marriage, or parenting.

7. The method for directing advertisements of claim 5, wherein the determined language of the advertisements is the native language of the ethnic group if the identified at least one of the life stages of the culture cycle model to which the potential consumers belong is parenting or identity.

8. The method for directing advertisements of claim 1, further comprising the steps of:
identifying a plurality of locations visited by the members of the ethnic group;
assigning a culture level rating to each of the plurality of locations based on a frequency of visits by the members of the ethnic group;
generating a geofence associated with each of the plurality of locations;
for each of the plurality of locations visited by users having mobile devices, each mobile device having a device identifier assigned to the mobile device, performing the steps of:
when a mobile device enters the geofence associated with a selected location of the plurality of locations, retrieving the device identifier assigned to the mobile device; and
storing the retrieved device identifier in a list of device identifiers assigned to mobile devices that have entered the geofence associated with the selected location; and
for each of the device identifiers in the stored list of device identifiers assigned to mobile devices that have entered the geofences associated with the plurality of locations, associating a culture level rating of the mobile device with the device identifier assigned to the mobile device, wherein the culture level rating is based on a number of the plurality of locations visited by the user of the mobile device and the culture level rating assigned to each of the plurality of locations visited by the user,
wherein the step of directing advertisements further comprises the steps of:
requesting the device identifiers assigned to the mobile devices with culture level ratings meeting a selected threshold corresponding to the identified at least one of the life stages of the culture cycle model to which the potential consumers of the product belong; and
directing advertisements in the determined language of the advertisements to the users of the mobile devices with the requested device identifiers assigned to the mobile devices with culture level ratings meeting the selected threshold.

9. The method for directing advertisements of claim 8, wherein the step of associating a culture level rating of the mobile device with the device identifier assigned to the mobile device further comprises the steps of:
weighting the culture level rating of the mobile device based on the number of the plurality of locations visited by the user of the mobile device to obtain a weighted culture level rating of the mobile device, wherein weighting includes increasing the culture level rating of the mobile device for each additional location of the plurality of locations visited by the user of the mobile device; and
associating the weighted culture level rating of the mobile device with the device identifier assigned to the mobile device.

10. The method for directing advertisements of claim 8, further comprising the steps of:
after the step of storing the retrieved device identifier in a list of device identifiers assigned to mobile devices that have entered the geofence associated with the selected location, cross-checking the retrieved device identifier assigned to the mobile device for generally daily reoccurrence of the retrieved device identifier in the stored list of device identifiers assigned to mobile devices that have entered the geofence associated with the selected location; and
removing the retrieved device identifier assigned to the mobile device from the stored list of device identifiers.

11. The method for directing advertisements of claim 8, wherein the plurality of life stages represented in the culture cycle model include at least college, marriage, parenting, and identity, and the determined language of the advertisements is English if the identified at least one of the life stages of the culture cycle model to which the potential consumers belong is college, marriage, or parenting.

12. The method for directing advertisements of claim 8, wherein the plurality of life stages represented in the culture cycle model include at least college, marriage, parenting, and identity, and the determined language of the advertisements is the native language of the ethnic group if the identified at least one of the life stages of the culture cycle model to which the potential consumers belong is parenting or identity.

13. A method for directing advertisements to potential consumers of a product, the consumers being a subset of members of an ethnic group associated with a homeland country and a native language, comprising:
identifying a plurality of locations visited by the members of the ethnic group;
assigning a culture level rating to each of the plurality of locations based on a frequency of visits by the members of the ethnic group;
generating a geofence associated with each of the plurality of locations;
for each of the plurality of locations visited by users having mobile devices, each mobile device having a device identifier assigned to the mobile device, performing the steps of:
when a mobile device enters the geofence associated with a selected location of the plurality of locations, retrieving the device identifier assigned to the mobile device;
storing the retrieved device identifier in a list of device identifiers assigned to mobile devices that have entered the geofence associated with the selected location;
cross-checking the retrieved device identifier for generally daily reoccurrence in the stored list of device identifiers assigned to mobile devices that have entered the geofence associated with the selected location; and
removing the retrieved device identifier from the stored list of device identifiers;
for each device identifier in the stored lists of device identifiers assigned to mobile devices that have entered the geofences associated with the plurality of locations, associating a culture level rating of the mobile device with the device identifier assigned to the mobile device, wherein the culture level rating is based on a number of the plurality of locations visited by the user of the mobile device and the culture level rating assigned to each of the plurality of locations visited by the user;
requesting the device identifiers assigned to the mobile devices with culture level ratings meeting a selected threshold; and
directing advertisements to the users of the mobile devices with the requested device identifiers with culture level ratings meeting the selected threshold.

14. The method for directing advertisements of claim 13, wherein the selected threshold is determined by performing the steps of:
generating a culture cycle model for the ethnic group representing a plurality of life stages of the members based on information data associated with the members of the ethnic group including an age, a household size, a household income, and a number of visits to the homeland country for each of the members; and
identifying in the culture cycle model at least one of the plurality of life stages to which the potential consumers of the product belong, wherein the selected threshold corresponds to the identified at least one of the life stages of the culture cycle model to which the potential consumers of the product belong.

15. The method for directing advertisements of claim 14, wherein the plurality of life stages represented in the culture cycle model include at least college, marriage, parenting, and identity, and further wherein the culture cycle model for the ethnic group is generated using formulas
$$α = \sqrt{number of visits to homeland country \times household size} and$$
$$β = \sqrt{household size \times household income} ,$$
wherein α and β define a height and a width of the culture cycle model, and further wherein each of the members of the ethnic group is assigned to one of a plurality of age groups based on the age of the member, and a quantity of the members of the ethnic group belonging to each of the age groups defines a thickness of the culture cycle model at each of the plurality of life stages of the members.

16. The method for directing advertisements of claim 15, further comprising the step of:
selecting a language of the advertisements between English and the native language associated with the ethnic group based on the identified at least one of the life stages of the culture cycle model to which the potential consumers of the product belong.

17. The method for directing advertisements of claim 16, wherein the selected language of the advertisements is English if the identified at least one of the life stages of the culture cycle model to which the potential consumers belong is college, marriage, or parenting.

18. The method for directing advertisements of claim 16, wherein the selected language of the advertisements is the native language of the ethnic group if the identified at least one of the life stages of the culture cycle model to which the potential consumers belong is parenting or identity.

19. A system for directing advertisements to potential consumers of a product, the consumers being a subset of members of an ethnic group associated with a homeland country and a native language, comprising:
one or more processors; and
processing logic executable by the one or more processors to perform the steps of:
retrieving information data associated with the members of the ethnic group, the information data comprising an age, a household size, a household income, a number of visits to the homeland country for each of the members;
generating a culture cycle model for the ethnic group representing a plurality of life stages of the members including at least college, marriage, parenting, and identity based on the information data associated with the members of the ethnic group including the age, the household size, the household income, and the number of visits to the homeland country for each of the members using formulas
$$α = \sqrt{number of visits to homeland country \times household size} and$$
$$β = \sqrt{household size \times household income} ,$$
wherein α and β define a height and a width of the culture cycle model, and further wherein each of the members is assigned to one of a plurality of age groups based on the age of the member, and a quantity of the members belonging to each of the age groups defines a thickness of the culture cycle model at each of the plurality of life stages of the ethnic group;
identifying in the culture cycle model at least one of the plurality of life stages to which the potential consumers of the product belong;
determining characteristics of the advertisements to be directed to the potential consumers of the product based on the identified at least one of the life stages of the culture cycle model to which the potential consumers belong, wherein the determined characteristics include a language of the advertisements; and
directing advertisements in the determined language to the potential consumers of the product.

20. The system for directing advertisements of claim 19, wherein the selected language of the advertisements is English if the identified at least one of the life stages of the culture cycle model to which the potential consumers belong is college, marriage, or parenting, and the selected language of the advertisements is the native language of the ethnic group if the identified at least one of the life stages of the culture cycle model to which the potential consumers belong is identity.
